(19) United States
(12) Patent Application Publication
(10) Pub. No.: US 2002/0009994 A1
(43) Pub. Date: Jan. 24, 2002

(54) Aircraft frequency identification

(76) Inventor: William G. Sample, Paola, KS (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/902,968

(22) Filed: Jul. 10, 2001

Related U.S. Application Data
(60) Provisional application No. 60/217,667, filed on Jul. 10, 2000.

(51) Int. Cl. H04Q 7/20

(52) U.S. Cl. 455/431; 455/67.1; 455/67.7

(57) ABSTRACT

A method and device for displaying radio frequency information, including a circuit or processor for retrieving various radio frequency information that are correlated to each of the various communication and navigational frequencies, including such information as the name of the facility transmitting, the frequency station type, the station identifier, the runway number, and the final approach course. The method and device include means for displaying the retrieved radio frequency information.

This application claims the benefit of U.S. Provisional Application Ser. No. 60/217,667, filed in the name of William G. Sample on Jul. 10, 2000, the complete disclosure of which is incorporated herein by reference.

### FIELD OF THE INVENTION

The present invention is directed to communication devices for aircraft and, more particularly, to aircraft communication and navigation devices that determine information corresponding to a radio frequency, and displays the information on a cockpit display.

### BACKGROUND OF THE INVENTION

Modem aircraft pilots must send and receive information to and from a large number of facilities. For example, a pilot beginning a flight ordinarily will set the communication equipment to the frequency for the originating airport's Automatic Terminal Information Service (ATIS) to learn the local weather conditions, winds, and runways(s) and instrument approach(es) currently in use. Then, the pilot may contact a Clearance Delivery (CLR) facility on another frequency to obtain permission to depart the airport. Thereafter, the pilot may contact a Ground Control (GRND) facility on another frequency for permission to use the taxiways. After that, the pilot may contact the Control Tower (TWR) and requests permission to take off. Once airborne, the pilot may contact a Flight Service Station (FSS) on another frequency to open a previouslyfiled flight plan.

Once airborne, the pilot may contact a Departure Control (DEP) facility on another frequency for instructions until the aircraft leaves the controlled airspace. Thereafter, the pilot may contact the appropriate sector of an Air Route Traffic Control Center (Center or CTR) having responsibility for the airspace through which the aircraft is passing on another frequency for advisories and/or instructions en-route to the destination airport. Since the aircraft may pass through multiple sectors for a Center before reaching the destination airport, the pilot may have to change frequencies whenever passing from one sector to another. Should the aircraft intend to enter or pass through Class B, C or D controlled airspaces during the flight, then the pilot must contact the Approach Control (APP) facility or TWR of the controlled airspace to inform them of a desire to enter or pass through the controlled airspace. The APR or TWR for each such controlled airspace typically will have its own communication frequency.

If the pilot desires to learn of any important weather information during the flight, he or she may tune to a Hazardous In-flight Weather Advisory Service (HIWAS) on another frequency. The pilot also may contact an Enroute Flight Advisory Service (EFAS or Flight Watch) of the FSS that services the area that the aircraft is passing through on another frequency for additional weather information. An FSS frequency other than a Flight Watch frequency may be contacted to determine the status of Special Use Airspace (SUA's) such as restricted areas and Military Operations Areas (MOA's), and other information.

If the destination airport is a non-tower-controlled airport, the pilot may obtain weather information as he or she nears the airport by tuning to an Automated Surface Observation System (ASOS) or Automated Weather Observing System (AWOS) at their designated frequencies. The pilot may obtain other information and services at such airports by contacting the airport on a separate unicom frequency. As the aircraft approaches the airport, the pilot usually broadcasts his or her intentions over the unicom frequency as well. If the airport does not have unicom capability, then the pilot will broadcast on a multicom frequency that typically is monitored by air traffic in the vicinity of the airport.

If a destination airport is within a terminal radar area, then the pilot may need to contact an Approach Control facility for the destination airport on the appropriate frequency for permission to enter the controlled airspace. Thereafter, the pilot will contact the Control Tower at the destination airport on the appropriate frequency for landing instructions. Once the aircraft is on the ground, the pilot may contact Ground Control at another frequency for taxiing instructions. Thereafter, the pilot may contact the FSS on another frequency to close the flight plan. The pilot may also choose to use the Unicom frequency to communicate with non-control facilities at the airport.

In addition to the voice communication frequencies noted above, the aircraft equipment uses additional frequencies for navigation. For example, different VOR frequencies associated with different VOR ground transmitters along the flight path may be used by a VOR receiver in the aircraft to guide the aircraft along a designated flight route. Frequencies associated with Tactical Air Navigation (TACAN) equipment associated with a VOR (the combination being referred to as a VORTAC), for example, may be used by Distance Measuring Equipment (DME) in the aircraft to indicate the distance between the aircraft and the VORTAC. Signals transmitted on other frequencies by nondirectional radio beacons (NDB's) may be used by Automatic Direction Finder (ADF) equipment in the aircraft to indicate the bearing of the aircraft relative to the NDB. During instrument-guided landings a localizer transmitter at an airport runway transmits signals at another frequency for horizontal guidance of the aircraft to the longitudinal center of the runway, and a glide slope transmitter transmits signals at another frequency for vertical guidance of the aircraft to the desired glide slope for the runway. While newer aircraft equipment automatically selects the appropriate glide slope frequency from a selected localizer frequency, older aircraft equipment require the pilot to select each frequency independently.

Clearly, the pilot of an aircraft must be cognizant of and must use a large number of communication and navigation frequencies for a successful flight. Keeping track of all the required and desired frequencies can be very difficult, especially during high cockpit workload during these periods such as departure and approach, and confusion can occur, which can result in radio frequency misuse. Failure to use the proper frequency at the proper time can have serious consequences. Indeed, fatal crashes have resulted from a pilot being tuned to the wrong frequency for a particular airspace.

### SUMMARY OF THE INVENTION

The present invention overcomes the limitations of the prior art by providing a device in the cockpit that enhances pilot workload efficiency and reduces the confusion that leads to communication and navigational errors by providing display information that is correlated to each of the various communication and navigational frequencies, including such information as the name of the facility transmitting, the frequency station type, the station identifier, the runway number, and the final approach course.

The present invention also provides continuous monitoring, in contrast to prior art systems that rely on a single check by the pilot. The display information correlated to the various communication and navigational frequencies is thus updated as a function of the aircraft's current position.

The development of inexpensive large format color displays and inexpensive memory for information storage make practicing the present invention feasible for aircraft. One embodiment of the present invention is sized for installation and operation in small business and general aviation aircraft.

The present invention provides an aircraft frequency identifier device having a means for storing radio frequency information; an accessing means, coupled to the storing means, for accessing the stored radio frequency information as a function of an input radio frequency signal and a position signal; and an output signal generating means, coupled to the accessing means, for generating an output signal as a function of the accessed radio frequency information.

According to one aspect of the invention, the means for storing radio frequency information includes means for storing the radio frequency information in a look-up table. The accessing means for accessing the stored radio frequency information includes a means for operating one or more algorithms for retrieving the radio frequency information from a look-up table.

According to another aspect of the invention, the device further includes receiving means for receiving the output signal, wherein the receiving means are coupled to the output signal generating means.

According to another aspect of the invention, the device further includes displaying means for displaying the accessed and retrieved radio frequency information, wherein the displaying means are coupled to the output signal receiving means.

According to still another aspect of the invention, the device also includes signal inputting means for inputting a radio frequency signal, wherein the signal inputting means are coupled to the output signal accessing means.

According to yet other aspects of the invention, the means for storing radio frequency information is a memory device having a database structured as a look-up table. The means for accessing the stored radio frequency information as a function of an input radio frequency signal and a position signal is an electrical circuit or processor, such as a microprocessor or digital signal processor. The circuit or processor is programmed with one or more algorithms that it operates for accessing and retrieving the radio frequency information from a look-up table and for generating an output signal as a function of the accessed and retrieved radio frequency information.

The receiving means for receiving the output signal from the circuit or processor is a display, which is structured to display the accessed and retrieved radio frequency information.

The signal inputting means for inputting a radio frequency signal is, for example, a control device or switch disposed on a control panel in close proximity to the display.

The invention also provides various different methods of accomplishing the same.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a particular embodiment of a front face of a navcomm device whereupon radio frequency information is displayed as a function of an input radio frequency signal and a position signal;

FIG. 2 illustrates one exemplary embodiment of the COM frequency display;

FIG. 3 illustrates one exemplary embodiment of the VLOC frequency display;

FIG. 4 illustrates one exemplary embodiment of the VLOC frequency display 74 during an instrument approach; and

FIG. 5 illustrates an exemplary block diagram one embodiment of the radio frequency information display device of the invention.

### DETAILED DESCRIPTION OF PREFERRED EMBODIMENT

In the Figures, like numerals indicate like elements.

The present invention is a device and method for identifying an aircraft frequency. The aircraft frequency identifier device receives a radio frequency control signal via the display and retrieves information from an onboard database correlated to the radio frequency. The retrieved information is displayed on a cockpit color, or monochrome display.

The present invention integrates an onboard information database and processor to display useful information about a tuned radio frequency. The device automates the retrieval process, such that no explicit actions are required to enable device operation. The simple tuning of a radio frequency causes a database search for information corresponding to the most likely, i. e., nearest, facility using the tuned radio frequency based upon the current aircraft position.

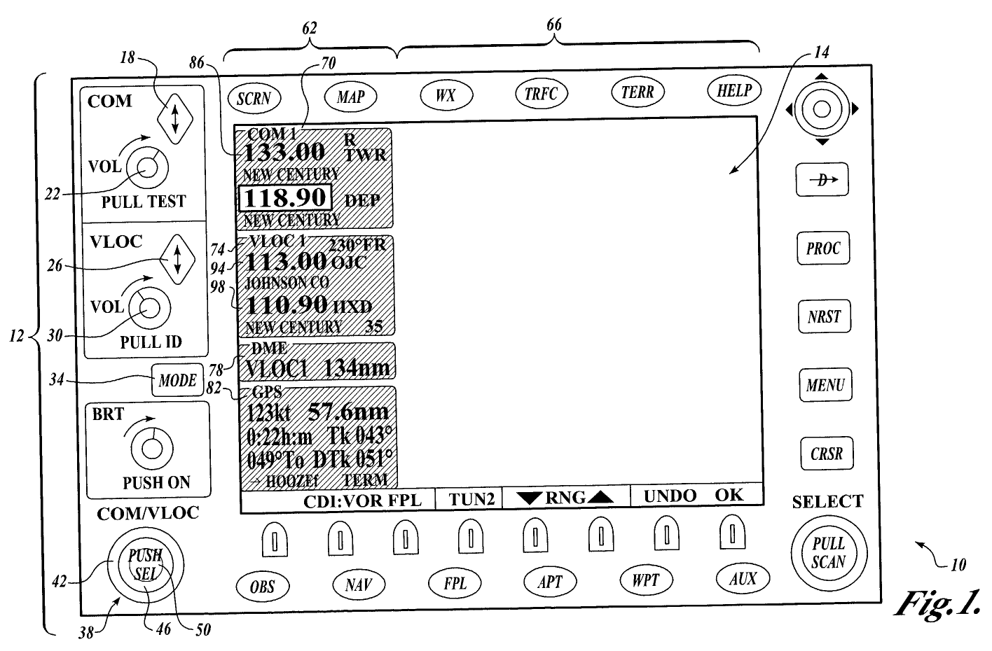

FIG. 1 shows a particular embodiment of a front face of a navcomm device 10 according to the present invention. The navcomm device 10 includes control panel 12 and a display 14. The control panel 12 includes such control features as a communication (COM) frequency transfer switch 18, a COM volume/test control 22 that controls volume when rotated and defeats the squelch when pulled, a VOR localizer (VLOC) frequency transfer switch 26, a VLOC volume/ID control 30 that controls volume when rotated and causes the identification code to be heard when pulled, a mode switch 34, a concentric control device 38 comprising a rotatable outer knob 42, a rotatable inner knob 46 and a centrally disposed push button 50. Other buttons and control devices shown are not relevant to the present invention and are not described.

The display 14 includes a left side display portion 62 and a right side display portion 66. The contents of these display portions 62, 66 depend upon the set display mode for the navcomm device 10. When the navcomm device 10 is in active frequency entry mode or standby frequency entry mode, the right side display portion 66 may provide various flight information that is not relevant to the present invention and is not described.

In FIG. 1, the left side display portion 62 includes a COM frequency display 70, a VLOC frequency display 74, a distance measuring equipment (DME) display 78, and a GPS display 82. Examples of data are displayed for clarity only and not to limit the invention in any way. The DME display 78 includes an identifier of the source of the station to which distance is being measured (VLOC 1), and the distance to the station (shown as 134 nm). The GPS display 82 indicates aircraft data such as ground speed (shown as 123 kt), distance from the active waypoint (57.6 nm), estimated time of arrival to the waypoint (shown as 0:22 h:m), actual track (shown as TK 043°), desired track (DTk 051°), bearing to and identifier of the waypoint (shown as 049° To HOOZEf), and navigation phase (shown as TERM).

The display modes relevant to this invention include a standby frequency entry mode and an active frequency entry mode. These display modes are discussed in more detail below.

FIG. 2 illustrates one exemplary embodiment of the COM frequency display 70. In this example, the COM frequency display 70 displays an active COM frequency 86 (shown as 118.90) and a standby COM frequency 90 (shown as 133.00). Indicated together with the active COM frequency 86 is the station type 87 (DEP for departure) to the right of the frequency 86, a status indicator 88 (shown as T for transmit) above the station type, and the facility name 89 (shown as Kansas City) below the frequency. Indicated together with the standby COM frequency 90 is the standby station type 91 (shown as TRW) to the right of the frequency and the standby facility name 92 (shown as New Century) below the frequency. The active COM frequency 86 can be swapped with the standby COM frequency 90, and vice versa, by pressing COM frequency transfer switch 18 in a well known manner.

FIG. 3 illustrates one exemplary embodiment of the VLOC frequency display 74. In this example, the VLOC frequency display 74 displays an active VLOC frequency 94 (shown as 113.00) and a standby VLOC frequency 98 (shown as 110.90). Indicated together with the active VLOC frequency 94 is the station identifier 95 (shown as OJC) to the right of the frequency 94, the direction 96 (shown as 230°) to or from (FR) the facility indicated above the station identifier 95, and the facility name 97 (shown as Johnson Co) below the frequency 94. Indicated together with the standby VLOC frequency 98 is the standby station identifier 99 (IIXD for instrument approach) to the right of the frequency 98 and the standby facility name 100 (shown as New Century) below the frequency 98. The runway designation 101 (shown as 35) is indicated to the right of the facility name 100 and below the station identifier 99.

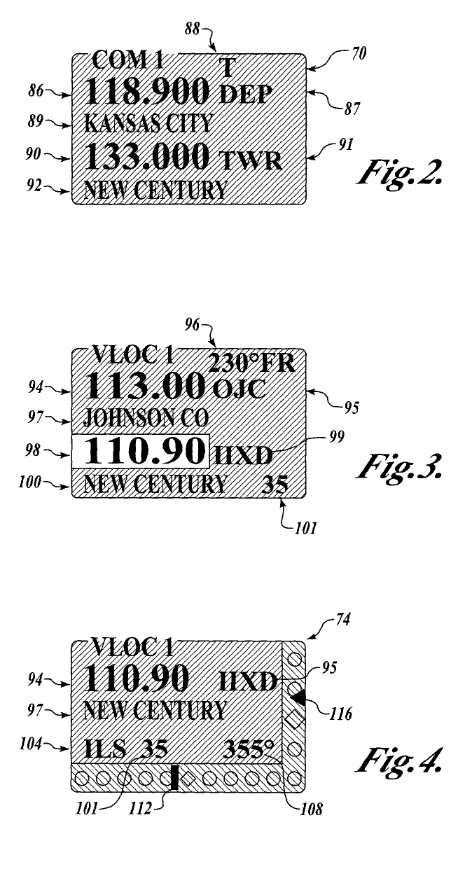

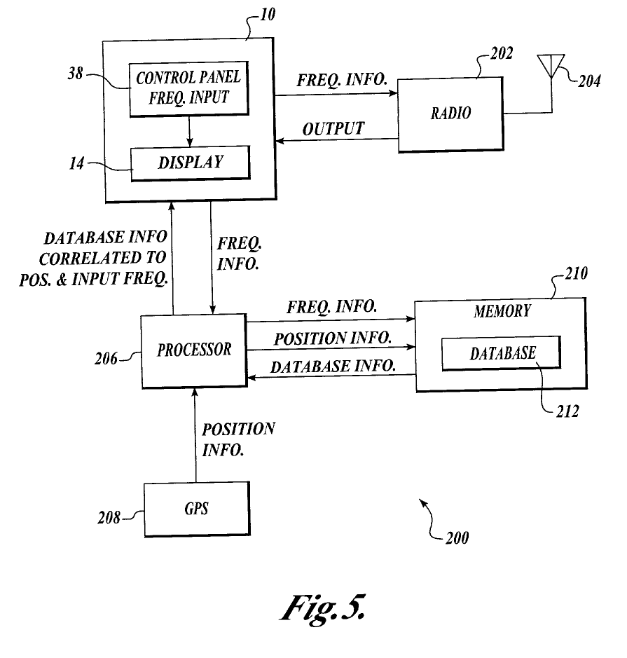

FIG. 4 illustrates one exemplary embodiment of the VLOC frequency display 74 during an instrument approach. In this example, the VLOC frequency display 74 displays an active VLOC frequency 94 (shown as 110.90) without a standby VLOC frequency 98. Indicated together with the active VLOC frequency 94 is the station identifier 95 (shown as IIXD for instrument approach) to the right of the frequency 94 and the facility name 97 (shown as New Century) below the frequency 94. Indicated to the left below the facility name 97 is the station type 104 (shown as “ILS” for Instrument Landing System: the system that provides lateral, along-course, and vertical guidance to aircraft attempting to land). Indicated to the right of the station type 104 is the runway designation 101 (shown as 35), and to the right of the runway designation 101 is indicated the runway final approach course 108, i.e., the runway centerline, (shown as 355°). Horizontal 112 and vertical 116 deviation pointers are provided along the display bottom and right side, respectively. The deviation pointers 112, 116 indicate the aircraft's horizontal and vertical position relative to the final approach course 108 and elevation envelopes according to data received by radio and form no part of the present invention.

The present invention is a radio communication and navigation system that assists a pilot in the proper radio frequency use, by displaying information correlating to that radio frequency. According to the invention, for a given frequency at a given aircraft position, much of the information shown in the display 14 of FIGS. 2, 3, and 4 is determined by reference to a look-up table as a function of the aircraft's current position. Information such as current station type 87, 104, facility names 89, 97, station identifier 95, runway number 101, and final approach course 108 are displayed to the pilot, thereby providing a valuable tool with which to verify the proper frequency selection.

The standby information is also provided by reference to a look-up table as a function of the aircraft's current position. Thus, in FIG. 2 the standby station type 91 and standby facility name 92 information for the given standby COM frequency 90 are determined from the look-up table as a function of the aircraft's current position and displayed on the display 14.

In FIG. 3, the standby station identifier 99 and the standby facility name 100 for the given standby VLOC frequency 98 are determined from the look-up table as a function of the aircraft's current position and displayed on the display 14.

FIG. 5 is a functional block diagram 200 embodying the present invention. According to the invention disclosed in FIG. 5, when the pilot enters a frequency, the nearest facility, i.e., closest to the aircraft's present position, using the input radio frequency is located in an onboard database. The radio frequency information retrieved from the stored database is then displayed near the entered frequency on a color or monochrome cockpit video display. The display changes with aircraft position or when the pilot enters a different frequency.

The desired radio frequency, either current or standby, is input to the appropriate communication device, e.g., the COM or VLOC device, in a well-known manner via the knobs 42, 46 and the push button 50 of the control device 38 on the front face of the navcomm device 10, as shown in FIG. 1. The input radio frequency is displayed on the COM frequency display 70 or VLOC frequency display 74 portion of the display 14 as either the active frequency 86, 94, respectively, or standby frequency 90, 98, respectively, as shown in FIGS. 2-4. The input radio frequency is communicated to an onboard receiver 202, which begins to receive the radio frequency signal via an antenna 204.

The input radio frequency is simultaneously communicated to an electrical circuit or an onboard processor 206, such as a microprocessor, a digital signal processor, or another suitable processor. The processor 206 may be either a dedicated processor or a processor shared with other onboard equipment. The processor 206 is coupled to receive the input radio frequency signal and a position signal, which is received at a predetermined sampling rate. The position signal is, for example, a position signal from an onboard positioning device 208, such as a global positioning system (GPS) receiver or another suitable positioning device. The processor 206 is also coupled to an onboard memory device 210 containing a database 212 of stored radio frequency information, which includes such information as the station type 87, 91 , 104, facility names 89, 92, 97, station identifier 95, runway number 101, and final approach course 108 information, or other useful information corresponding to a particular input radio frequency. The radio frequency information is stored in the database 212 in the form of a look-up table correlated with input radio frequency and position. The processor 206 operates one or more conventional look-up algorithms to access the database 212, using the input radio frequency and position data to retrieve the appropriate radio frequency information corresponding to the input radio frequency and position signals. The processor then operates one or more conventional algorithms to return the radio frequency information to the navcomm device 10 for display on the appropriate COM frequency display 70 or VLOC frequency display 74 portion of the display 14.

The display changes when the pilot inputs a different frequency. The processor 206 receives the new frequency and accesses the database 212 using the new frequency and a current position signal to retrieve the corresponding radio frequency information, which is communicated back to the navcomm device 10 for display on the appropriate COM frequency display 70 or VLOC frequency display 74 portion of the display 14.

Optionally, the radio frequency information displayed on the COM frequency display 70 or VLOC frequency display 74 portions of the display 14 is updated as the aircraft changes position relative to the stationary, earth-bound broadcasting facilities, such that radio frequency information corresponding to the nearest facility is displayed as the aircraft moves along its course. The processor 206 samples the position signal periodically and accesses the database 212 as a function of the input radio frequency and the updated position to retrieve updated radio frequency information. The processor then returns the updated radio frequency information to the navcomm device 10 for display on the appropriate COM frequency display 70 or VLOC frequency display 74 portion of the display 14.

According to one embodiment of the invention, the displayed radio frequency information is updated to reflect the changing position of the aircraft according to a predetermined protocol or set of rules. For example, if the pilot inputs a frequency into the navcomm device 10, the processor 206 operates to periodically sample the position signal and access the database 212 as a function of the input radio frequency and the updated position information to retrieve updated radio frequency information. The processor then returns the updated radio frequency information to the navcomm device 10 for display on the appropriate COM frequency display 70 or VLOC frequency display 74 portion of the display 14.

Alternatively, if the pilot inputs the name of the location using conventional functionality. For example, existing systems such as long range navigation (GPS) devices provide this functionality. Such functionality permits the display of the nearest FSS or Center frequencies. and have lists of frequencies used at airports. The pilot selects from a list of frequencies on the device and commands the device to send the frequency to the COM or NAV control device. The radio frequency information displayed on the COM frequency display 70 or VLOC frequency display 74 portion of the display 14 remains constant and is not changed as a function of the updated position information.

While the preferred embodiment of the invention has been illustrated and described, it will be appreciated that various changes can be made therein without departing from the spirit and scope of the invention.

What is claimed is:

1. A device, comprising:
a database of radio frequency information stored as a function of radio frequency; and
a circuit coupled to the database and operating one or more algorithms for accessing the database as a function of an input radio frequency signal and generating a display signal as a function of an input radio frequency signal.

2. The device of claim 1 wherein:
the circuit is further structured to receive a position signal; and
the one or more algorithms include one or more algorithms for accessing the database as a function of both the input radio frequency signal and a position signal and generating a display signal as a function of an input radio frequency signal and a position signal.

3. The device of claim 2, further comprising a display coupled to the circuit, the display structured to receive the display signal and display the radio frequency information.

4. The device of claim 2 wherein the circuit is a processor.

5. An aircraft frequency identifier device, comprising:
a database of stored radio frequency information; and
a processor coupled to the database and operating one or more algorithms for generating a display signal as a function of an input radio frequency signal and a position signal.

6. The device of claim 5 wherein the one or more algorithms operated by the processor access the database as a function of an input radio frequency signal and a position signal.

7. The device of claim 6 wherein the one or more algorithms operated by the processor retrieve from the database a portion of the radio frequency information corresponding to an input radio frequency signal and a position signal.

8. The device of claim 7, further comprising a display coupled to the processor for receiving the display signal and generating a display as a function thereof.

9. The device of claim 8, further comprising a control device structured to input a radio frequency to one of the processor and the display.

10. A device, comprising:
a database of radio frequency information stored as a function of radio frequency and position; and
a processor having a first input structured to receive a signal indicative of an input radio frequency and a second input structured to receive a signal indicative of position, the processor coupled to the database and operating one or more algorithms for retrieving a portion of the radio frequency information as a function of a signal indicative of an input radio frequency received on the first input and a signal indicative of position received on the second input.

11. The device of claim 10 wherein the processor further operates one or more algorithms for generating a display signal indicative of the portion of the retrieved radio frequency information.

12. The device of claim 11, further comprising a display coupled to receive the display signal.

13. The device of claim 11, further comprising a control device coupled to the first input of the processor and structured to input a radio frequency to the processor.

14. The device of claim 11, further comprising a control device coupled to the first input of the processor and structured to input a radio frequency to the display.

15. The device of claim 11 wherein the second input of the processor is structured to receive an output signal of a global positioning system that is indicative of position.

16. An aircraft frequency identifier, comprising:
a means for storing radio frequency information;
an accessing means, coupled to the storing means, for accessing the stored radio frequency information as a function of an input radio frequency signal and a position signal; and
an output signal generating means, coupled to the accessing means, for generating an output signal as a function of the accessed radio frequency information.

17. The device of claim 16 wherein the means for storing radio frequency information includes means for storing the radio frequency information in a look-up table.

18. The device of claim 17 wherein the accessing means includes a means for operating one or more algorithms for retrieving the radio frequency information from a look-up table.

19. The device of claim 16, further including receiving means, coupled to the output signal generating means, for receiving the output signal.

20. The device of claim 19, further including displaying means, coupled to the output signal receiving means, for displaying the accessed radio frequency information.

21. The device of claim 16, further including signal inputting means, coupled to the output signal accessing means, for inputting a radio frequency signal.

22. A device, comprising:
database means for storing radio frequency information as a function of radio frequency and position; and
processor means for receiving a first signal indicative of an input radio frequency and a second signal indicative of position, the processor means coupled to the database means for retrieving a portion of the radio frequency information as a function of a first signal indicative of an input radio frequency and a second signal indicative of position.

23. The device of claim 22 wherein the processor means for retrieving a portion of the radio frequency information further includes processor means for operating one or more algorithms for retrieving a portion of the radio frequency information.

24. The device of claim 23 wherein the processor means further includes signal generating means for generating a signal indicative of the portion of the radio frequency information retrieved by the processor means.

25. The device of claim 24, further comprising display means, coupled to the processor means, for receiving the signal indicative of the portion of the radio frequency information and displaying the portion of the radio frequency information.

26. A method of identifying an aircraft frequency, comprising:
storing radio frequency information;
accessing the stored radio frequency information as a function of an input radio frequency signal and a position signal; and
generating an output signal as a function of the accessed radio frequency information.

27. The method of claim 26 wherein the storing radio frequency information includes storing the radio frequency information in a look-up table.

28. The method of claim 27 wherein the accessing the stored radio frequency information includes operating one or more algorithms for retrieving the radio frequency information from a look-up table.

29. The method of claim 26, further including receiving the output signal the output signal and displaying the accessed radio frequency information.

30. The method of claim 26, further including inputting a radio frequency signal for use in the accessing the stored radio frequency information.

31. The method of claim 30, further including inputting a position signal for use in the accessing the stored radio frequency information.

32. A method of identifying an aircraft frequency, comprising:
storing radio frequency information in a database as a function of radio frequency and position;
receiving in a processor a first signal indicative of an input radio frequency and a second signal indicative of position; and
retrieving from the database a portion of the radio frequency information as a function of a first signal indicative of an input radio frequency and a second signal indicative of position.

33. The method of claim 32 wherein the retrieving a portion of the radio frequency information further includes operating one or more algorithms for retrieving a portion of the radio frequency information.

34. The method of claim 33, further including generating a signal indicative of the portion of the retrieved portion of the radio frequency information.

35. The method of claim 34, receiving the signal indicative of the retrieved portion of the radio frequency information and displaying the retrieved portion of the radio frequency information.
